(19) United States
(12) Patent Application Publication
(10) Pub. No.: US 2010/0190067 A1
(43) Pub. Date: Jul. 29, 2010

(54) MANAGEMENT OF FUEL CONTAMINATORS IN FUEL CELLS

(76) Inventors: Hao Tang, Montreal (CA); Dingrong Bai, Dorval (CA); David Elkaïm, Ville Saint-Laurent (CA); Jean-Guy Chouinard, Ville Saint-Laurent (CA)

Correspondence Address: OGILVY RENAULT LLP, 1, Place Ville Marie, SUITE 2500, MONTREAL, QC, H3B 1R1, CA

(21) Appl. No.: 12/376,858

(22) PCT Filed: Aug. 7, 2007
(86) PCT No.: PCT/CA07/01383

§ 371 Date: Feb. 9, 2009

Related U.S. Application Data
(60) Provisional application No. 60/835,905, filed on Aug. 7, 2006.

(51) Int. Cl. H01M 8/06

(52) U.S. Cl. 429/410

(57) ABSTRACT

There is described a method for managing a fuel cell system having a fuel contaminator present in an anode reactant, the method comprising: monitoring a fuel contaminator concentration in the anode reactant of a fuel cell stack, the fuel cell stack having a plurality of individual fuel cell units each having a membrane electrode assembly (MEA); detecting an increase in the fuel contaminator concentration in the anode reactant; and increasing, when the increase in fuel contaminator concentration is detected, a concentration of a compound that chemically reacts with the fuel contaminator in the anode reactant by a mass transfer through a membrane in the fuel cell system to reduce the fuel contaminator concentration.

### CROSS-REFERENCE TO RELATED APPLICATIONS

The present application claims priority of US Provisional Patent Application filed on Aug. 7, 2006 and bearing Ser. No. 60/835,905.

### TECHNICAL FIELD

This application relates to the field of fuel cells, and more particularly, to dealing with fuel contaminator in the anode reactant of fuel cells.

### BACKGROUND OF THE INVENTION

A low concentration of fuel contaminators such as carbon monoxide (CO) is usually found in the anode reactant of a fuel cell system when hydrocarbon fuel such as natural gas or liquefied petroleum gas (LPG) is chemically processed such as by steam reforming, autothermal reforming or partial oxidation with water-gas shift reaction and CO cleanup processes to provide for the system's hydrogen source. When carbon monoxide enters into the fuel cells, particularly proton exchange membrane fuel cells (PEMFCs), the catalysts are poisoned and the fuel cell performance is therefore degraded. To eliminate CO's negative effect on fuel cell performance, there is provided a common approach of so-called “air-bleeding” in which a certain amount of air, depending on the level of CO concentration in fuel, is externally supplied and mixed to the anode reactant continually (using up about 1% to 10% of anode reactant) prior to enter the fuel cell stack. The oxygen contained in air will then oxidize CO into CO₂ under presence of a Pt (or Pt/Ru) catalyst inside the fuel cell, and thus fuel cell performance is expected to be improved.

During the majority of time of the fuel cell operation, however, the fuel processor works well and the CO concentration is considerably low so that no air or only a small amount of air is needed for CO oxidization reaction. In this case, the external air-bleeding system becomes even harder to control and operate.

There is a need to overcome the drawbacks of fuel cell systems due to fuel contaminates.

### SUMMARY OF THE INVENTION

In accordance with a first broad aspect of the present invention, there is provided a method for managing a fuel cell system having a fuel contaminator present in an anode reactant, the method comprising: monitoring a fuel contaminator concentration in the anode reactant of a fuel cell stack, the fuel cell stack having a plurality of individual fuel cell units each having a membrane electrode assembly (MEA); detecting an increase in the fuel contaminator concentration in the anode reactant; and increasing, when the increase in fuel contaminator concentration is detected, a concentration of a compound that chemically reacts with the fuel contaminator in the anode reactant by a mass transfer through a membrane in the fuel cell system to reduce the fuel contaminator concentration.

In accordance with a second broad aspect of the present invention, there is provided a fuel cell system comprising: a fuel cell stack comprising: a plurality of individual fuel cell units each having a membrane electrode assembly (MEA); a first inlet to deliver an anode reactant to an anode side of each of the individual fuel cell units; a second inlet to deliver a cathode reactant to a cathode side of each of the individual fuel cell units; a diagnosis module for detecting an increase in a fuel contaminator in the anode reactant; and a fuel contaminator control module connected to the diagnosis module and adapted to increase a concentration of a compound that chemically reacts with the fuel contaminator in the anode reactant by a mass transfer through a membrane in the fuel cell system to reduce the fuel contaminator concentration.

The system may also have an anode humidifier sub-system using cathode off gas as a water source. In this case, the fuel contaminate control module may go through the anode humidifier sub-system to increase/decrease pressure of the cathode off gas/anode reactant in order to alter the oxygen transfer from cathode off gas to supplying fuel stream, respectively.

The term “oxygen” is used throughout the description to represent the compound that chemically reacts with the contaminator. It should be understood that the oxygen can be replaced by any compound that chemically reacts with the contaminator or by any fluid comprising the compound. Furthermore, it should be understood that the term “oxygen” is equivalent to the term “dioxygen”.

Furthermore, the term “carbon monoxide” is used throughout the description to represent the fuel cell anode poisoning contaminator. It is understood that the anode poisoning contaminator may also be another chemical compound, such as H₂S, ammonia, volatile organic compounds (VOCs), etc.

### BRIEF DESCRIPTION OF THE DRAWINGS

Further features and advantages of the present invention will become apparent from the following detailed description, taken in combination with the appended drawings, in which:

FIG. 1 is a cross-sectional side view of a membrane electrode assembly showing the oxygen flux in accordance with one embodiment of the invention;

FIG. 2 is a cross-sectional side view of a proton exchange membrane type anode humidifier sub-system using COG as a water source in accordance with one embodiment of the invention;

FIG. 3a is a block diagram of an embodiment of the fuel cell system in accordance with the present invention;

FIG. 3b is a block diagram of an embodiment of the fuel cell system using an anode humidifier sub-system in accordance with the present invention;

FIG. 4 is a flow chart illustrating an embodiment of the method of the present invention; and

FIG. 5 is a flow chart illustrating an embodiment of the method of the present invention wherein the increase of CO concentration is determined by monitoring cell voltage.

It will be noted that throughout the appended drawings, like features are identified by like reference numerals.

### DETAILED DESCRIPTION

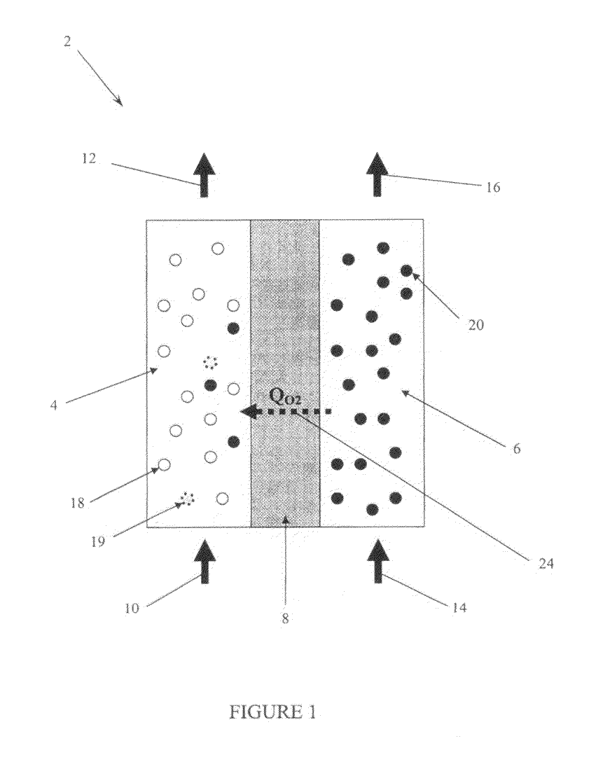

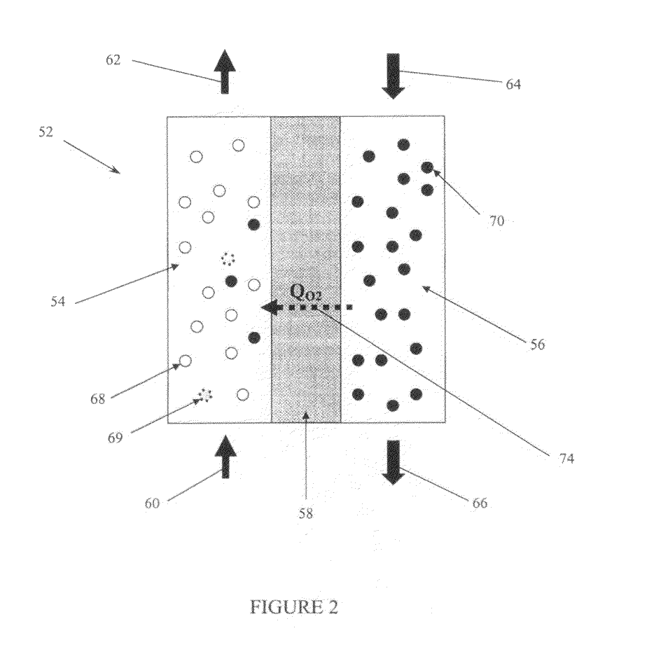

FIG. 1 illustrates the flow of oxygen in a membrane electrode assembly (MEA) found in an individual fuel cell unit of a fuel cell stack and FIG. 2 in a proton exchange membrane (PEM) type anode humidifier sub-system. The anode reactant is humidified before entering into the stack using cathode off gas (COG). If a polymer type membrane is used in the anode humidifier (such as Nafion™), the oxygen (or air) flux Q_{O}_{₂} from COG to anode reactant (or from cathode to anode via MEA) can be described as:

$${Q}_{{0}_{2}} = {D}_{{0}_{2}} S \cdot \frac{( {p}_{1} - {p}_{2} )}{L}$$

where D_{O}_{₂} is the O₂ mass transfer coefficient, S is the solubility of O₂ in the membrane, L is the membrane thickness, and p₁ and p₂ are the O₂ partial pressures from cathode and anode sides, respectively. The oxygen flux amount depends on membrane thickness and anode/cathode pressure. The oxygen can be replaced with any chemical compound that reacts with carbon monoxide and diffuses through a membrane. One way to increase the mass transfer of oxygen through the membrane consists in increasing the O₂ partial pressures difference (p1-p2) which can be achieved by at least one of increasing the O₂ partial pressure pl and decreasing the O₂ partial pressure p2.

FIG. 1 illustrates one embodiment of the invention. An MEA 2 comprises an anode side 4, a cathode side 6 and a membrane 8 therebetween. An anode side may include (but not be limited to) the combination of anode flow fields, and/or anode gas diffusion layer (GDL) and anode electrode. The cathode side may include (but not be limited to) the combination of cathode flow fields, and/or cathode GDL and cathode electrode.

An input anode reactant stream 10 enters the anode side 4 by an anode reactant inlet. This stream comprises molecules of fuel 18 and molecules of carbon monoxide 19. The output anode reactant stream 12 exits the anode side 4 by an anode reactant outlet. A cathode reactant stream 14 enters the cathode side 6 by a cathode reactant inlet. The cathode reactant stream 14 comprises oxygen molecules 20 and potentially other chemical compounds (such as nitrogen when air is used as oxidant). The output cathode reactant stream 16 exits the cathode side 6 by a cathode reactant outlet. In the present example, the anode reactant stream 10 and the cathode reactant stream 14 are co-current flow relative to the MEA 2, but it is understood that they could be counter-current flow or cross-flow. If the partial pressure of oxygen molecules 20 in the cathode side 6 of the MEA is higher than partial pressure of oxygen molecules 20 in the anode side 4 of the MEA, a mass transfer (by any underlying mechanisms including diffusion, convection, etc) of oxygen molecules 20 occurs from the cathode side 6 to the anode side 4, which is illustrated by arrow 24. The gradient of oxygen partial pressure (which is equal to the oxygen molar fraction multiplied by the total pressure of the reactant stream) can be achieved by at least one of increasing the cathode reactant pressure and decreasing the anode reactant pressure.

Various methods known to those skilled in the art are available to alter the anode and/or cathode pressure. For example, precision pressure regulators installed on either or both the anode and cathode outlets can adjust the back pressure to respective values, as desired. Anode and cathode stoichiometry can also be adjusted to provide different preferred pressures on each side (i.e. anode and cathode side).

FIG. 2 illustrates another embodiment of the present invention. An anode humidifier 52 comprises an anode reactant side 54, a humidifying source side 56 and a membrane 58 therebetween. An input anode reactant stream 60 enters the anode reactant side 54 of the anode humidifier 52, the stream comprising fuel molecules 68 and carbon monoxide molecules 69. The output anode reactant stream 62 exits the anode humidifier 52 by an outlet which may be connected to the anode reactant inlet of the fuel cell stack. A humidifying source stream 64 enters the humidifying source side 56 of the anode humidifier 52, the stream comprising oxygen molecules 70, water molecules and other chemical compounds such as nitrogen. In the illustrated example, the anode reactant stream 62 and the humidifying source stream 64 are arranged as counter-current flow but they could also be co-current flow or cross flow. If the partial pressure of oxygen in the humidifying source 64 in the humidifying source side 56 is higher than the partial pressure of the oxygen in anode reactant stream 62 in the fuel side 54, a mass transfer (by any underlying mechanisms including diffusion, convection) of oxygen molecules 70 from the humidifying source side 56 to the anode reactant side 54, which is illustrated by arrow 74. The gradient of partial pressure of oxygen can be achieved by at least one of increasing the pressure of the humidifying source 64 and decreasing the anode reactant 62 pressure. The humidifying source 64 can come from either a source external to the fuel cell stack or the stream of cathode reactant that exits the fuel cell stack.

It should be understood that the present system and method is not limited to proton exchange membrane fuel cells, but rather can be used for any type of fuel cell in which fuel contaminators (such as CO) are present in the anode reactant, thereby poisoning the cell catalysts.

Based on an average anode reactant fuel contaminator concentration during fuel cell operation, nominal membrane thickness is selected for the MEA membrane and/or the anode humidifier membrane. The higher the contaminator concentration in the anode reactant, the thinner the membrane should be for MEA and/or anode humidifier.

Injecting the O₂ molecules through the membrane of either the MEA or the anode humidifier results in not requiring additional accessories such as pipes, external sources of O₂ and modules to control the amount of O₂ molecules injected. This process can also be termed as in-cell or in-site internal air-bleeding. In addition, the utilization of anode side oxygen molecules transferred from the cathode side can be significantly increased compared to normal air bleeding processes, and hence reduce the chemical combustion reactions between fuel and extra oxygen in the anode side.

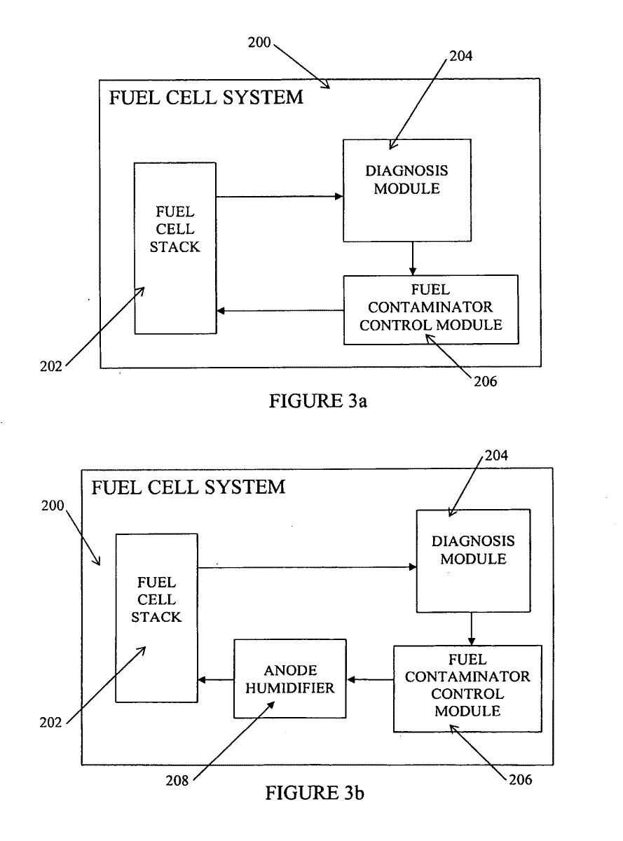

FIG. 3a is a block diagram showing an embodiment of the fuel cell system of the present invention. In the fuel cell system 200, the fuel cell stack 202 performance is monitored by a diagnosis module 204. If the diagnosis module 204 detects a decrease in the fuel cell stack 202 performance, it may perform a diagnosis to determine the root cause of the cell performance degradation, such as fuel starvation, water flooding or fuel contaminators. In the case that increased contaminator concentration has been detected, the diagnosis module 204 will trigger the fuel contaminator control module 206 to increase the transfer of a contaminator-reacting compound to the anode reactant and thereby decrease the contaminator concentration, as illustrated in FIG. 1. This may be done by adjusting the pressure of the cathode/anode reactants in the fuel cell stack 202. In one embodiment, the fuel cell system injects oxygen to control the carbon monoxide concentration in the anode reactant, but it should be understood that the fuel cell system can control the concentration of any contaminator and inject a compound that chemically reacts with the contaminator. It should also be understood that the diagnosis module 204 and the fuel contaminator control module 206 may also be external to the fuel cell system.

FIG. 3b illustrates an embodiment including an anode humidifier sub-system 208 that uses cathode off gas or a humidifying source external to the stack as a water source, such as the one illustrated in FIG. 2. When the diagnosis module 204 detects an increase in the CO concentration, it sends a detection signal to the fuel contaminator control module. After receiving the detection signal, the fuel contaminator control module 206 may go through the anode humidifier sub-system 208 to increase/decrease the pressure of the cathode off gas/anode reactant, respectively, as illustrated in FIG. 2. Alternatively, the pressure of the reactants in both the anode humidifier sub-system 208 and in the fuel cell stack 202 are adjusted in order to reduce the CO concentration. In one embodiment, the fuel cell system injects oxygen to control the carbon monoxide concentration in the anode reactant, but it should be understood that the fuel cell system can control the concentration of any contaminator and inject a compound that chemically reacts with the contaminator. It should also be understood that the diagnosis module 204, the fuel contaminator control module 206 and the anode humidifier 208 may also be external to the fuel cell system.

The diagnosis module may include devices such as a voltage measurement device for a cell or a stack. Other possible devices are measurement devices for stoichiometry, calculation means for theoretical calculations, or storage means for previous experiment results used for comparison.

According to an embodiment of the invention, the diagnosis module that monitors the fuel cell stack performance may include a module that monitors the average cell stack voltage (which is equal to the stack voltage divided by the number of cells) and/or individual cell voltage. All of the individual cells or only a certain number of the individual fuel cells can be monitored at any given time. The monitored fuel cells may be selected randomly or in a specific sequence. When the diagnosis module detects a drop in the average cell stack voltage and/or individual cell voltage, the diagnosis module concludes that CO concentration has increased in the anode reactant and will trigger the fuel contaminator control module to transfer O₂ molecules into the anode reactant from cathode side by adjusting anode/cathode and/or anode humidifier pressures to neutralize the CO molecules.

According to an embodiment of the invention, the diagnosis module that monitors the fuel cell stack performance may further include a module that monitors the anode and cathode stoichiometric variations. If the diagnosis module detects a drop in the average cell stack voltage and/or individual cell voltage and further detects no anode and cathode stoichiometric variations, the diagnosis module concludes that the decrease of the stack performance is due to an increase of contaminator concentration in the anode reactant. Then, the diagnosis module triggers the fuel contaminator control module to transfer the compound that chemically reacts with the contaminator into the anode reactant from the cathode side.

According to another embodiment of the invention, the diagnosis module that monitors the fuel cell stack performance comprises a contaminator detector such as a carbon monoxide detector that monitors the carbon monoxide concentration directly in the anode reactant. If the carbon monoxide detector detects an increase in the carbon monoxide concentration, the diagnosis module triggers the fuel contaminator control module to increase the oxygen concentration in the anode reactant. It should be understood that the contaminator detector is adapted to the kind of contaminator present in the anode reactant and the fuel contaminator control module is adapted to inject a compound that chemically reacts with the contaminator.

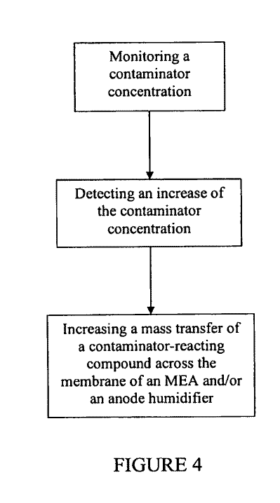

FIG. 4 illustrates the method for managing a fuel cell system having a fuel contaminator (such as carbon monoxide) present in an anode reactant. A contaminator concentration is monitored in the anode reactant entering a fuel cell stack.

If an increase of the contaminator concentration is detected, the pressure of at least one of the reactants is adjusted in the MEA and/or the anode humidifier to inject a compound that chemically reacts with the contaminator in the anode reactant.

In an embodiment of the method, monitoring the fuel contaminator concentration comprises monitoring the fuel contaminator concentration in the anode reactant with a fuel contaminator detector.

In an embodiment of the method, monitoring the contaminator concentration and detecting an increase of the contaminator concentration are performed by monitoring the fuel cell stack performance. If the fuel cell stack performance decreases, the fuel cell system concludes that the contaminator concentration in the anode reactant has increased.

Monitoring the fuel cell stack performance may comprise at least one of monitoring the average cell voltage and monitoring the individual cell voltage. An increase of the contaminator concentration in the anode reactant is detected when the average fuel cell voltage and/or the individual fuel cell voltage drop below a threshold. Only a certain number of the individual fuel cells may be monitored at any given time. The monitored fuel cells may be selected randomly or not.

In another embodiment, monitoring the fuel cell stack performance may also comprise monitoring the flow of the anode and/or cathode reactant. If the average fuel cell voltage and/or the individual fuel cell voltage drop below a threshold and the flow of anode and/or cathode reactant remains substantially unvaried, the fuel cell system detects an increase of the contaminator concentration in the anode reactant. Only a certain number of the individual fuel cells can be monitored at any given time. The monitored fuel cells may be selected randomly or not.

In one embodiment of the method, the threshold is set between and 100 mV below the operational voltage, for example, about 10 to 30 mv.

Monitoring the flow of the anode and/or cathode reactant may include monitoring the stoichiometry of the anode and/or cathode reactant. The fuel cell system may have the capability to measure the anode and/or the cathode flow. According to the total stack current and number of stack cells, the stoichiometry can be calculated. An alternative method to monitor the flow consists in monitoring the pressure change of anode/cathode reactant. During normal operation of the fuel cell system, the pressure will be increased if the flow rate increases (assuming all other operational parameters remained unchanged).

If the fuel cell system has detected an increase of the contaminator concentration, the compound that chemically reacts with the contaminator can be injected in the anode reactant stream either in the stack or in the anode humidifier. If the injection takes place in the stack, at least one of increasing the cathode reactant pressure in the stack and decreasing the anode reactant pressure in the stack increases the flux of the compound from the cathode side to the anode side via the MEA membrane. If the injection takes place in the anode humidifier, at least one of increasing the humidifying source pressure and decreasing the anode reactant pressure in the anode humidifier increases the flux of the compound from the humidifying source side to the anode reactant side via the membrane of the anode humidifier. The increased concentration of the compound in the anode reactant then improves fuel cell performance. In an embodiment, the contaminator to be controlled is carbon monoxide and the compound that reacts with the contaminator is oxygen. In this embodiment, the O0₂ molecules chemically react with the CO molecules to CO₂ molecules which have minor effects on fuel cell performance compared to the CO molecules.

In accordance with one embodiment, the amount of compound that reacts with the contaminator transferred into the anode reactant can be adjusted with respect to the importance of the drop of voltage. As the compound is transferred into the anode reactant stream, it suppresses the contaminator present in the anode reactant and the fuel cell stack performance increases. As the fuel cell stack performance gradually increases and the contaminator concentration decreases, the amount of transferred compound is gradually decreased. When the fuel cell stack performance reaches its original level and stabilizes, the transfer of compound is stopped.

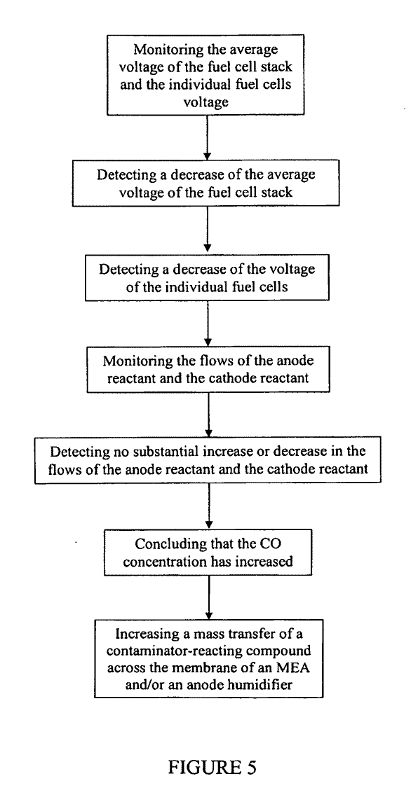

FIG. 5 illustrates one embodiment of the method used for the present invention. Stack performance is monitored, taking into account average cell voltage and individual cell voltages. If the average cell performance decreases and individual cell voltages decrease, then the system monitors the flow of the anode and cathode reactants in order to determine if the decrease of the voltages could be due to variations in these flows. If the anode and cathode reactants flows are within their operational range, the system detects an increase of the CO concentration in the anode reactant stream. In order to eliminate the harmful effect of carbon monoxide on the fuel cell stack performance, oxygen is transferred into the anode reactant. The transfer of oxygen in the anode reactant can be achieved by adjusting the reactant pressures in the stack and/or the anode humidifier. The adjustment of pressures comprises at least one of increasing the pressure of the cathode reactant and decreasing the pressure of the anode reactant in the stack if the transfer of O₂ molecules occurs in the stack. If the transfer of oxygen occurs in the anode humidifier, the adjustment of pressures comprises at least one of increasing the pressure of the humidifying source and decreasing the pressure of the anode reactant in the anode humidifier. This can be done for both the fuel cell stack (MEA) and the anode humidifier, if a separate anode humidifier is present. The amount of oxygen injected into the anode reactant can be adjusted with respect to the importance of the drop of voltage. As oxygen is transferred in the anode reactant stream, it reacts with the carbon monoxide and the average cell voltage increases. As the average cell voltage gradually increases, the amount of transferred oxygen is gradually decreased. When the average cell voltage reaches its operational range and stabilizes, the transfer of oxygen is stopped.

It should be noted that a random or low quantity of oxygen may be injected instead of a predetermined quantity. In this case, the injection of oxygen is subsequently increased or decreased as function of the fuel contaminator concentration in the anode reactant.

It should be understood that the contaminator can be other than carbon monoxide and the compound that chemically reacts with the contaminator can be other than oxygen.

The embodiments of the invention described above are intended to be exemplary only. The scope of the invention is therefore intended to be limited solely by the scope of the appended claims.

1. A method for managing a fuel cell system having a fuel contaminator present in an anode reactant, the method comprising:
monitoring a fuel cell stack performance, said fuel cell stack having a plurality of individual fuel cell units;
detecting a change in said fuel cell stack performance;
performing a diagnosis to determine a root cause of said change in said fuel cell stack performance;
detecting an increase in a fuel contaminator concentration in said anode reactant; and
increasing, when said increase in fuel contaminator concentration is detected, a concentration of a compound that chemically reacts with the fuel contaminator in said anode reactant by a mass transfer through a membrane in said fuel cell system to reduce said fuel contaminator concentration.

2. A method as claimed in claim 1, wherein each one of said plurality of fuel cell units comprises a membrane electrode assembly having a chemical reaction membrane and said mass transfer occurs through said chemical reaction membrane in each membrane electrode assembly in said fuel cell stack.

3. A method as claimed in claim 1, wherein said mass transfer occurs through a humidification membrane in an anode humidifier in said fuel cell system.

4. (canceled)

5. (canceled)

6. A method as claimed in claim 2, wherein said increasing a concentration of a compound that chemically reacts with the fuel contaminator comprises at least one of increasing a pressure of a cathode reactant entering the fuel cell stack and decreasing a pressure of the anode reactant entering the fuel cell stack, thereby increasing said concentration of said compound in the anode reactant.

7. (canceled)

8. (canceled)

9. A method as claimed in claim 3, wherein said increasing a concentration of a compound that chemically reacts with the fuel contaminator comprises at least one of increasing a pressure of a humidifying input source and decreasing a pressure of the anode reactant in said anode humidifier, thereby increasing said concentration of said compound in the anode reactant.

10. A method as claimed in claim 1, wherein said increasing a concentration of a compound that chemically reacts with the fuel contaminator comprises increasing an oxygen concentration in the anode reactant.

11. A method as claimed in claim 1, wherein said monitoring said fuel cell stack performance comprises monitoring an average fuel cell stack voltage, and said detecting said change in said change in said fuel cell stack performance comprises detecting a decrease in said average fuel cell stack voltage.

12. A method as claimed in claim 11, wherein said monitoring an average fuel cell stack voltage comprises considering less than all of the fuel cell units in said fuel cell stack.

13. A method as claimed in claim 11, wherein said monitoring said fuel cell stack performance comprises monitoring a flow of the anode reactant and a flow of a cathode reactant to confirm that said decrease in said average fuel cell stack voltage is due to an increase in fuel contaminator concentration.

14. (canceled)

15. A method as claimed in claim 11, wherein said monitoring said fuel cell stack performance further comprises monitoring voltage level of said fuel cell units, and said detecting said change in said fuel cell stack performance comprises detecting a decrease in said voltage level of said fuel cell units.

16. A method as claimed in claim 15, wherein said monitoring voltage level of said fuel cell units comprises monitoring less than all of said fuel cell units in said stack.

17. A method as claimed in claim 11, wherein said detecting an increase in the fuel contaminator concentration comprises detecting that said average fuel cell stack voltage has fallen below a predetermined threshold.

18. A fuel cell system comprising:
a fuel cell stack comprising:
a plurality of individual fuel cell units;
a first stack inlet to deliver an anode reactant to an anode side of each of the individual fuel cell units;
a second stack inlet to deliver a cathode reactant to a cathode side of each of the individual fuel cell units;
a diagnosis module for detecting a change in a fuel cell stack performance, performing a diagnosis to determine a root cause of said change in said fuel cell stack performance and detecting an increase in a fuel contaminator concentration in said anode reactant; and
a fuel contaminator control module connected to said diagnosis module and adapted to increase a concentration of a compound that chemically reacts with said fuel contaminator in said anode reactant by a mass transfer through a membrane in said fuel cell system to reduce said fuel contaminator concentration.

19. A fuel cell system as claimed in claim 18, wherein each one of said plurality of fuel cell units comprises a membrane electrode assembly (MEA) having a chemical reaction membrane and said fuel contaminator control module is adapted to cause said mass transfer to occur through said chemical reaction membrane in each membrane electrode assembly in said fuel cell stack.

20. A fuel cell system as claimed in claim 18, further comprising an anode reactant humidifier comprising a humidification membrane and wherein said fuel contaminator control module is adapted to cause said mass transfer to occur through said humidification membrane.

21. (canceled)

22. (canceled)

23. A fuel cell system as claimed in claim 19, wherein said fuel contaminator control module is adapted to at least one of increase a pressure of a cathode reactant entering the fuel cell stack and decrease a pressure of the anode reactant entering the fuel cell stack.

24. (canceled)

25. (canceled)

26. A fuel cell system as claimed in claim 20, wherein said fuel contaminator control module is adapted to at least one of increase a pressure of a humidifying input source and decrease a pressure of the anode reactant in said anode humidifier.

27. A fuel cell system as claimed in any one of claims 18 to 26, wherein said diagnosis module is adapted to monitor an average fuel cell stack voltage and detect a decrease in said average fuel cell stack voltage.

28. A fuel cell system as claimed in claim 27, wherein said diagnosis module considers less than all of the fuel cell units in said fuel cell stack when monitoring said average fuel cell stack voltage.

29. A fuel cell system as claimed in claim 27, wherein said diagnosis module is adapted to monitor a flow of the anode reactant and a flow of a cathode reactant to confirm that said decrease in said average fuel cell stack voltage is due to an increase of the fuel contaminator concentration.

30. (canceled)

31. A fuel cell system as claimed in claim 27, wherein said diagnosis module is adapted to monitor voltage level of said fuel cell units to detect a decrease in said voltage level of said fuel cell units.

32. A fuel cell system as claimed in claim 31, wherein said diagnosis module monitors less than all of said fuel cell units in said stack.

33. A fuel cell system as claimed in claim 27, wherein said diagnosis module is adapted to detect that said average fuel cell stack voltage has fallen below a predetermined threshold.

34. A method for managing a fuel cell system having a fuel contaminator present in an anode reactant, the method comprising:
monitoring a fuel contaminator concentration in the anode reactant of a fuel cell stack, said fuel cell stack having a plurality of individual fuel cell units each having a membrane electrode assembly (MEA);
detecting an increase in the fuel contaminator concentration in said anode reactant; and
increasing, when said increase in fuel contaminator concentration is detected, a concentration of a compound that chemically reacts with the fuel contaminator in said anode reactant by a mass transfer through a humidifying membrane in an anode humidifier in said fuel cell system to reduce said fuel contaminator concentration.

35. A fuel cell system comprising:
an anode humidifier comprising a humidifying membrane; and
a fuel cell stack comprising:
a plurality of individual fuel cell units each having a membrane electrode assembly (MEA);
a first stack inlet to deliver an anode reactant to an anode side of each of the individual fuel cell units, said first stack inlet being connected to a humidifier outlet of said anode humidifier;
a second stack inlet to deliver a cathode reactant to a cathode side of each of the individual fuel cell units;
a diagnosis module for detecting an increase in a fuel contaminator in the anode reactant; and
a fuel contaminator control module connected to said diagnosis module and adapted to increase a concentration of a compound that chemically reacts with said fuel contaminator in said anode reactant by a mass transfer through said humidifying membrane in said fuel cell system to reduce said fuel contaminator concentration.
